(19) United States
(12) Patent Application Publication
(10) Pub. No.: US 2018/0038107 A1
(43) Pub. Date: Feb. 8, 2018

(54) REINFORCED COMPOSITE STRUCTURE USEFUL AS STUDS, JOISTS, RAFTERS AND OTHER STRUCTURAL AND NON-STRUCTURAL BUILDING COMPONENTS

(71) Applicant: Robert Lee Taylor, Knightdale, NC (US)

(72) Inventor: Robert Lee Taylor, Knightdale, NC (US)

(21) Appl. No.: 15/671,558

(22) Filed: Aug. 8, 2017

Related U.S. Application Data
(60) Provisional application No. 62/372,032, filed on Aug. 8, 2016.

(51) Int. Cl. E04C 3/29; E04C 3/293; B28B 1/52; E04B 1/30; B28B 1/14; B28B 23/18; E04C 3/292; E04C 5/01

(52) U.S. Cl. CPC E04C 3/29; E04C 3/292; E04C 3/293; E04C 5/012; E04B 1/30; B28B 1/14; B28B 23/18; B28B 1/525

(57) ABSTRACT

A composite building member such as a stud, joist or rafter. The composite building member includes a composite composition including concrete and wood fiber. In addition, a reinforcing structure is embedded into the composite structure. The reinforcing member comprises two elongated C-shaped channels and a plurality of ties interconnected between the C-shaped channels.

### CROSS-REFERENCE TO RELATED APPLICATION

This application claims priority under 35 U.S.C. §119(e) from the following U.S. provisional application: application Ser. No. 62/372032 filed on Aug. 8, 2016. That application is incorporated in its entirety by reference herein.

### FIELD OF THE INVENTION

The present invention relates to a composite building member such as a stud that is reinforced with metal, steel, fiberglass, plastic or other reinforcing material.

### SUMMARY OF THE INVENTION

The present invention entails a composite building member that is useful as a stud, joist, rafter or other structural or non-structural building component. In one embodiment, the composite building member is made up of concrete, wood fiber and fiberglass and includes a metal reinforcing structure embedded therein.

### DESCRIPTION OF THE DRAWINGS

FIG. 1 is a perspective view of the stud of the present invention.

FIG. 2 is a longitudinal sectional view of the stud of the present invention.

FIG. 3 is a cross-sectional view of the stud of the present invention.

FIG. 4 is a longitudinal sectional view of a joist.

FIG. 5 is a cross-sectional view of the joist.

FIG. 6 is a perspective view of a rafter.

FIG. 7 is a cross-sectional view of the rafter.

### DESCRIPTION OF EXEMPLARY EMBODIMENTS

The present invention relates to a composite building member that is reinforced with metal, steel, fiberglass, plastic or other suitable material. The composite building member is a molded product that, in one embodiment, is made up of concrete (cement and sand), wood fiber and fiberglass. As noted above, a reinforcing structure is embedded in the molded building product. The resulting composite structure may be structural or non-structural in nature.

There are many uses for the composite building member discussed herein. The building member can be used as a stud, floor joist, ceiling joist, rafter, or any other component that is typically found in a wood building or structure or even found in a light steel frame structure. In one of the examples discussed herein, this new composite structure can be utilized to make component of a fence, including fence pickets and fence posts.

To form the molded product, the dry components, concrete, wood fiber and fiberglass are mixed with water or an aqueous solution. The resulting mixture is then placed in a mold after the reinforcing structure has been appropriately laid or positioned in the mold. A molding process ensues and this ultimately results in the production of a composite building member in accordance with the present invention.

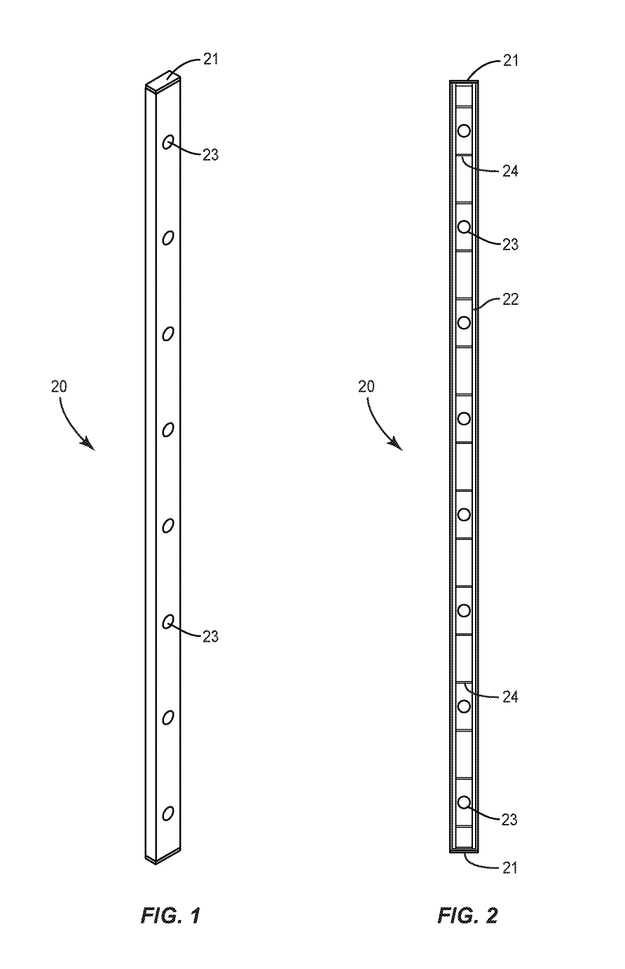

Turning to the drawings, FIGS. 1-3 show an example of the composite building member and this example constitutes a stud. A stud is specifically designed as a vertical member that forms a part of a wall. The stud in FIGS. 1-3 is referred to generally by the numeral 20. First, it should be appreciated that the size or dimensions of the stud 20 can vary. That is, the length, width and thickness of the stud 20 can vary. In this case, as discussed above, the stud is a molded product and is formed, in one example, by mixing concrete, wood fiber and fiberglass in water or an aqueous solution and then placing the mixture (composite slurry) in the mold. It is understood and appreciated that a reinforcing structure is placed in the mold such that after the composite building member is molded, the reinforcing structure is appropriately embedded therein. In one example, the dry constituents used to form the mixture comprise approximately 90% concrete, 6% wood fiber and 4% fiberglass. This can vary and other supplemental or filler materials can be added as desired.

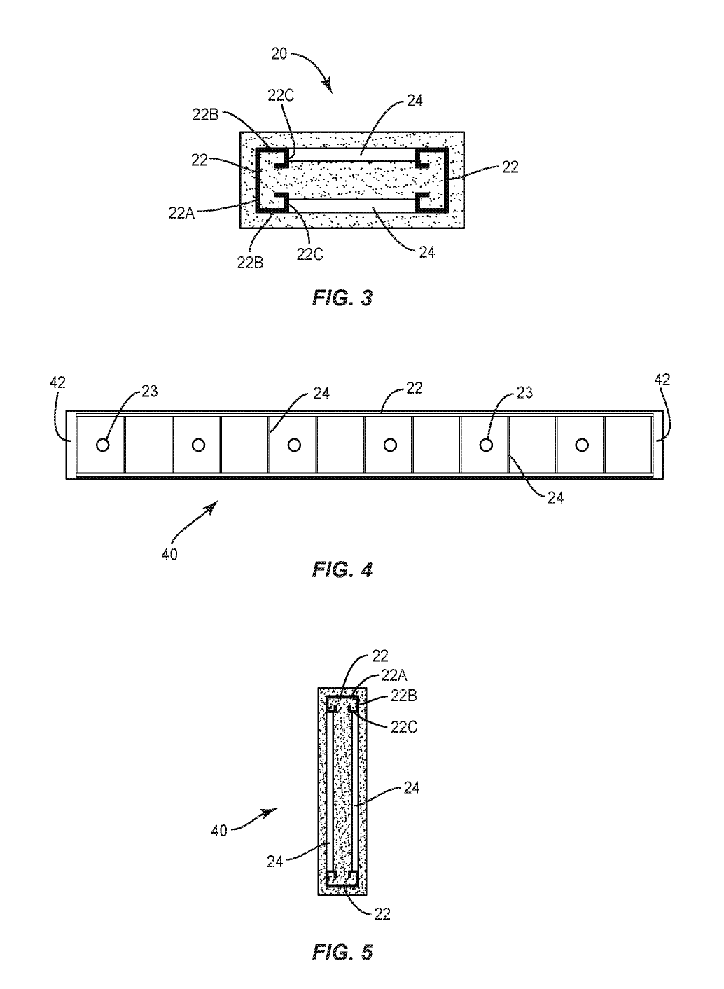

The reinforcing structure for the exemplary stud can be constructed of metal, steel, fiberglass, plastic or other suitable materials that will lend an appreciable amount of strength to the stud. In the example disclosed herein, the reinforcing structure for the stud 20 is metal. There are various ways that an internal metal assembly or frame can be constructed and laid out in the stud. FIGS. 1-3 simply show one example. In this case, two C-shaped parallel channels 22 extend along opposed edges of the stud and extend substantially the entire length of the stud. Each C-shaped channel 22, shown in FIG. 2, includes a web 22A, a flange 22B and an angled return 22C. See FIG. 3. These two C-shaped parallel channels 22 are interconnected on each side of the stud 20 by a series of horizontally extending and spaced apart transverse ties 24. In this embodiment, the ties are also constructed of metal. Note that the ties are parallel to each other and that the ties extend between the returns 22C of the C-shaped channels 22. Various means can be utilized to connect the C-shaped channels 22 with the transverse ties 24. In one case, the metal components can be connected together by fasteners, such as screws or bolts. In another embodiment, these steel components can be welded together. When the mixture of concrete, wood fiber, fiberglass and water are disposed in the mold, it follows that this mixture surrounds and encompasses the components that constitute the metal reinforcement. Of particular note is that this composite mixture will integrate into the internal areas defined by the C-shaped channels 22 and will essentially become locked therein once the molded stud 20 is produced.

In a preferred embodiment of the stud 20, it is beneficial to provide a nailing surface or plate 21 at opposite ends of the stud. Typically, this nailing structure will extend across the opposed ends of the stud 20. This will enable nails to be driven into this structure if required. In the case of the embodiment shown in FIGS. 1-3, the transverse ties 24 disposed about the extreme ends of the stud 20 can, in some cases, function as a nail receptor.

When the stud or other building component is reinforced with metal or steel, it is preferred to provide one or more utility passthroughs or openings 23 at various points along the length of the composite structure. This allows various utilities such as electric wiring, plumbing and a variety of other utilities to be threaded through these passthroughs without the need for drilling holes to accommodate these utilities. It should be pointed out that when these composite molded products are reinforced with metal or steel, they are not designed to be cut. In many cases, they are deemed structural members and should not be cut.

In the embodiment just discussed for the stud 20 and shown in FIGS. 1-3, the reinforcing structure is metal or steel. However, it is appreciated that the reinforcing structure can be plastic or fiberglass and if so, would generally be in a solid tubular form. This enables the stud 20 or other type of composite building member to be cut, drilled into or shaped as needed.

The stud, shown in FIGS. 1-3, again is just one example of how the composite structure described here can be employed. Composite structures according to the design and makeup just described can be designed and produced to serve as floor joists, ceiling joists, rafters and other structures in a building.

FIGS. 4 and 5 show a joist 40. The joist is constructed in the same manner as the stud shown in FIGS. 1-3 and discussed above. That is, the joist is made of up of a composite material. In one example, the composite material includes concrete and wood fibers. In another embodiment, the composite material may include concrete, wood fibers and fiberglass. The reinforcing structure and its orientation are shown in FIG. 5. It is essentially of the same design found in the stud shown in FIGS. 1-3. That is, the reinforcing structure includes two spaced apart C-shaped channels 22 that, in one embodiment, are constructed of metal. A series of ties 24 are interconnected between the C-shaped channels 22. There is one noticeable difference in the joist shown in FIGS. 4 and 5 from the stud shown in FIGS. 1-3. The joist includes opposed trim end portions 42. These trim end portions occupy a small portion of the joist on each end. In one example, these trim end portions extend approximately 1¼ inch. Note that the reinforcing structure terminates short of the opposed ends of the joist. Where the metal reinforcing structure terminates in this example defines the trim end portion. Providing the trim end portion on the opposed ends of the joist enables the joist to be precisely cut to conform to a particular dimension.

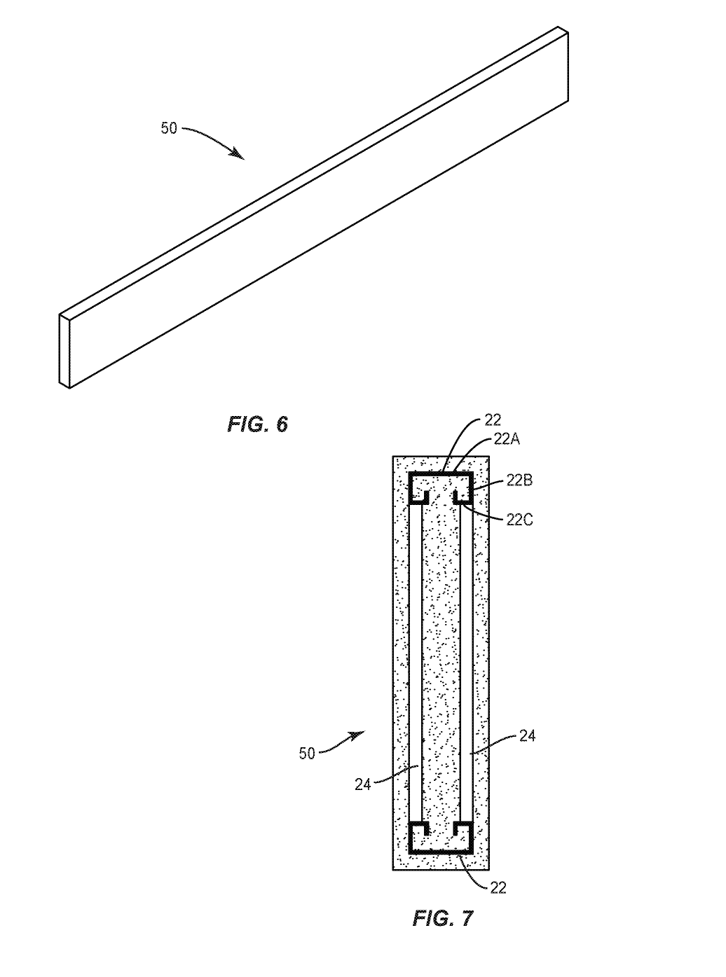

Turning to FIGS. 6 and 7, there is shown therein a rafter 50. The rafter conforms to the basic design of the stud shown in FIGS. 1-3 with the exception that the rafter does not include the utility passthroughs. But for that exception, the basic design is the same in that it includes a composite material and a reinforcing structure which essentially comprises the opposed C-shaped channels 22 and the interconnecting ties 24.

The term “joist” means a load carrying member extending horizontally across a floor or ceiling structure of a building. The term “rafter” means an elongated load bearing member found in a roof structure.

The present invention also includes a method of manufacturing a building member such as a stud, joist or rafter. The basic process entails mixing concrete and wood fibers with water to form a composite slurry. In some embodiments, the mixture may include concrete, wood fiber and fiberglass. This mixture constitutes a composite slurry. A mold is prepared and the reinforcing structure is placed in the mold as oriented in the drawings. The composite slurry is poured into the mold, embedding the reinforcing structure in the process. The mold is allowed to cure and dry and the composite building member is removed from the mold.

There are many advantages to the composite building structure or member discussed herein. First, the structure is resistant to rust and corrosion. It is also resistant to termites and fireproof.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A building member configured to form an element of a wall structure comprising:
an elongated molded stud comprising a composite material including concrete, wood fiber and fiberglass;
the molded stud including upper and lower sides, opposite side edges, and opposed ends;
a metal reinforcing structure embedded in the composite material that forms the stud, the metal reinforcing structure including:
i. a pair of spaced apart parallel C-shaped channels extending substantially the entire length of the stud;
ii. each C-shaped channel including a web, flange and a return;
iii. wherein the pair of C-shaped channels are particularly disposed in the composite material of the stud such that the web of each C-shaped channel faces a respective edge of the stud and wherein the returns of the pair of C-shaped channels are spaced apart and face each other;
iv. a series of longitudinally spaced and parallel extending ties connected to the returns and extending between the returns of the two C-shaped channels, the series of ties including a first group of ties that lie below an upper side of the stud and a second group of ties that lie above the lower side of the stud;
v. the ties of each group lie in substantially the same plane; and
a series of spaced apart utility openings formed in the stud.

2. The building member of claim 1 wherein the stud includes a pair of metal nailing plates secured to opposite ends of the stud.

3. The building member of claim 1 wherein on a dry basis the composite material comprises approximately 90% concrete, 6% wood fiber and 4% fiberglass.

4. A building member configured to form a stud, joist or rafter, comprising: an elongated molded member having opposed sides, opposed edges, and opposed ends; the elongated molded member comprising a composite material including at least concrete and wood fiber; a metal reinforcing structure embedded into the composite material of the molded member; and including (i) a pair of C-shaped metal channels extending substantially the entire length of the molded member; (ii) the C-shaped metal members including a web and a flange; (iii) wherein the webs of the pair of C-shaped metal channels face respective edges of the molded member; and (iv) a plurality of spaced apart ties interconnected between the spaced apart C-shaped channels.

5. The building member of claim 4 wherein the metal reinforcing structure terminates short of the opposed ends of the building member to define a trim end portion and wherein the trim end portion is free of the metal reinforcing structure and includes the composite material and wherein the trim end portion is configured to be cut such that the length of the building member can be precisely controlled.

6. The building member of claim 5 wherein the trim end portion formed on opposite end portions of the building member is of a length of approximately 1¼″ inches.

7. A method of constructing a composite building member where the building member comprises a stud, joist, or rafter, the method comprising: mixing concrete, wood fiber and water to form a composite slurry; pouring the composite slurry into a mold that includes a metal reinforcing structure that comprises a pair of spaced apart C-shaped metal channels where each C-shaped metal channel comprises a web and a pair of flanges and wherein the C-shaped channels are oriented with respect to each other such that the flanges thereof face each other and wherein there is provided a plurality of spaced apart ties that are interconnected between the two C-shaped metal channels; drying the composite slurry around the metal reinforcing structure to form a stud, joist or rafter comprised of a composite material that includes concrete and wood fiber, along with the metal reinforcing structure.
